(19) United States
(12) Patent Application Publication
(10) Pub. No.: US 2007/0198279 A1
(43) Pub. Date: Aug. 23, 2007

(54) Shipping management tool and method

(76) Inventors: Erik Scott Hallas, Ballston Spa, NY (US); Scott Hagar Mogavero, Schenectady, NY (US)

Correspondence Address: CANTOR COLBURN, LLP, 55 GRIFFIN ROAD SOUTH, BLOOMFIELD, CT, 06002, US

(21) Appl. No.: 11/357,779

(22) Filed: Feb. 17, 2006

(51) Int. Cl. G06Q 99/00

(52) U.S. Cl. 705/1

(57) ABSTRACT

A shipping management tool comprises a system that allows for information to be loaded therein. The tool can compile at least one of shipment and material information into the system; rating information representative of the material to be shipped; information concerning one or more carriers for the material to be shipped; evaluate the carriers based on one or more of existing and proposed contracts, contractual terms and desired contractual obligations; and determine an appropriate.

### BACKGROUND OF THE INVENTION

The invention relates generally to shipping management tools and methods. In particular, the invention relates to a shipping management tool and method that can manage a business′ material handling needs. Further, the invention relates to a shipping management tool and method that can globally manage a business′ material handling needs in a cost effective fashion.

Previously, scheduled shipment methods included manual and some automated systems and methods. These prior automated systems and methods, while effective for certain shipping criteria would often be inadequate for shipping requirements that were either straight forward or complex, such as those that required multiple routes, pick-ups, drop-offs, non-standard (one pick-up and a single drop-off location) requests, and the like. These prior automated systems and methods did not meet the needs of to transport material due to incorrect requirements communicated or specified by routing programs or people, either automated or manual. Additionally, some prior automated systems and methods, while effective for certain shipping criteria would often be inadequate for shipping requirements that were either straight forward or included complex shipment materials, which refers to shipments of non-standard sizes, weights, and/or shapes. These inadequacies would cause expedited shipping methods to be used, which is extremely costly and could caused shipment delay. This delay could then results in further monetary costs due to delays of the shipment being delayed (for example, for “time is of the essence” shipping) or even the shipment not being completed.

Further, these prior automated systems and methods comprised shipment tracking methods and systems that relied on at least some levels of manual input. While manual input can be reliable, it can also be a source of erroneous data, such as but not limited to dated data, inaccurate date and incorrect data. The erroneous data could result in inaccuracies in shipping preparation or in the actual shipment itself, both undesirable. These prior automated systems and methods were managed and controlled mostly through fax machines, in/out box processes, printers and telephone.

It would therefore be desirable to create a shipping management tool and method that can effectively manage material shipments, effectively manage global material shipments, and effectively manage material shipments of complex material shipments. Complex material refers to the size, weight and shape of material being shipped. In addition, it would therefore be desirable to create a shipping management tool and method that can effectively manage material shipments needed to move such complex material. In addition, it would therefore be desirable to create a shipping management tool and method that can effectively manage material shipments in a cost effective manner, for example shipments that can be consolidated where the opportunity is present, therefore reducing the need for multiple shipments.

### BRIEF DESCRIPTION OF THE INVENTION

Briefly, in accordance with one aspect of the present invention, a shipping management tool comprises a system that allows for information to be loaded therein. The tool can compile at least one of shipment and material information into the system; rating information representative of the material to be shipped; information concerning one or more carriers for the material to be shipped; evaluate the carriers based on one or more of existing and proposed contracts, contractual terms and desired contractual obligations; and determine an appropriate.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a generalized block diagram of the shipping management tool, as embodied by the invention;

FIG. 2 illustrates an exemplary process for the shipping management tool, as embodied by the invention;

FIG. 3 illustrates a banning (or elimination) process/module for carriers of the shipping management tool, as embodied by the invention; and

FIG. 4 illustrates a notification capability process of the shipping management tool, as embodied by the invention.

### DETAILED DESCRIPTION OF THE INVENTION

The invention provides shipping management tools and methods. In particular, the shipping management tool and method, as embodied by the invention, can manage a business′ material handling needs. Further, the shipping management tool and method, as embodied by the invention, can globally manage a business′ material handling needs in a cost effective fashion.

The shipping management tool and method, as embodied by the invention, that can effectively manage material shipments, effectively manage global material shipments, and effectively manage material shipments of complex material shipments. In this application, the term “complex material” refers to the size, weight and shape of material being shipped. In addition, the shipping management tool and method can effectively manage material shipments needed to move such complex material. In addition, the shipping management tool and method, as embodied by the invention, can effectively manage material shipments in a cost effective manner, for example shipments that can be consolidated where the opportunity is present, therefore reducing the need for multiple shipments.

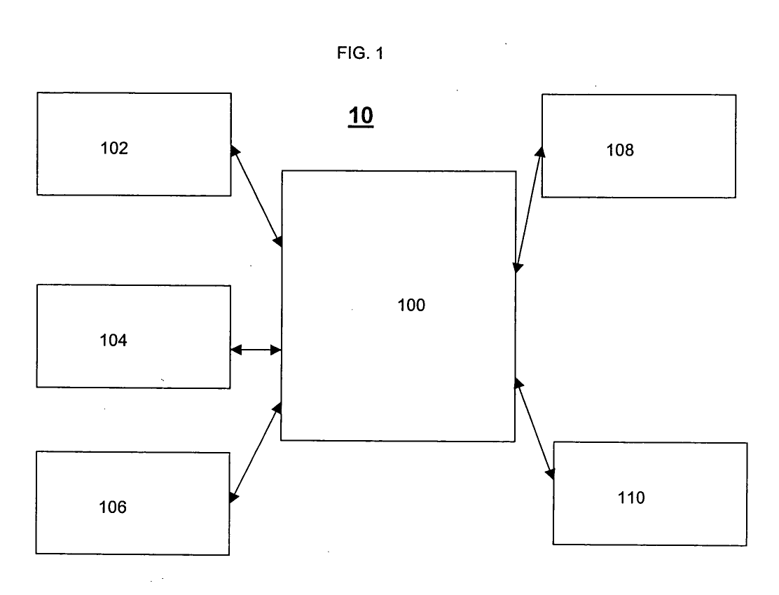

Accordingly, the shipping management tool and method, as embodied by the invention, (hereinafter “shipping management tool”) can utilize various computer technologies to manage, create and maintain material shipments. Referring now to the Figures and, more particularly, to FIG. 1, there is shown a generalized block diagram illustrating a shipping management tool 10 configured in accordance with the present invention. In particular, at its most simplistic implementation, the shipping management tool 10 includes at least a shipping management tool control or computer system 100. The control or computer system 100, as embodied by the invention, allows two-way communication between multiple shipping management tool 10 users, clients, and/or customers. For example, and in no way limiting of the invention, users, clients, and/or customers includes at least one shipping management tool planner 102, at least one shipping management tool tracker 104, at least one shipping management tool carrier 106, at least one shipping management tool administrator 108, and at least one shipping management tool system control 110. The responsibilities and functions of each of the at least one shipping management tool planner 102, at least one shipping management tool tracker 104, at least one shipping management tool carrier 106, at least one shipping management tool administrator 108, and at least one shipping management tool system control 110 will be described hereinafter, and with respect to the FIGURES.

The control or computer system 100, as embodied by the invention, The control or computer system 100 comprises any appropriate high-powered solid-state switching device. As illustrated, the control or computer system 100 is represented as a computer. However, this is merely exemplary of an appropriate high-powered control, which is within the scope of the invention. For example but not limiting of the invention, the control or computer system 100 comprises at least one of a silicon controlled rectifier (SCR), a thyristor, MOS-controlled thyristor (MCT) and an insulated gate bipolar transistor. In the illustrated embodiment, the control is implemented as a single special purpose integrated circuit, such as ASIC, having a main or central processor section for overall, system-level control, and separate sections dedicated performing various different specific combinations, functions and other processes under control of the central processor section. It will be appreciated by those skilled in the art that the control can also be implemented using a variety of separate dedicated or programmable integrated or other electronic circuits or devices, such as hardwired electronic or logic circuits including discrete element circuits or programmable logic devices, such as PLDs, PALs, PLAs or the like. The control can also be implemented using a suitably programmed general-purpose computer, such as a microprocessor or microcontrol, or other processor device, such as a CPU or MPU, either alone or in conjunction with one or more peripheral data and signal processing devices.

In general, any device or similar devices on which a finite state machine capable of implementing the flow charts, as illustrated in the application can be used as the control. As shown a distributed processing architecture is a preferred for maximum data/signal processing capability and speed.

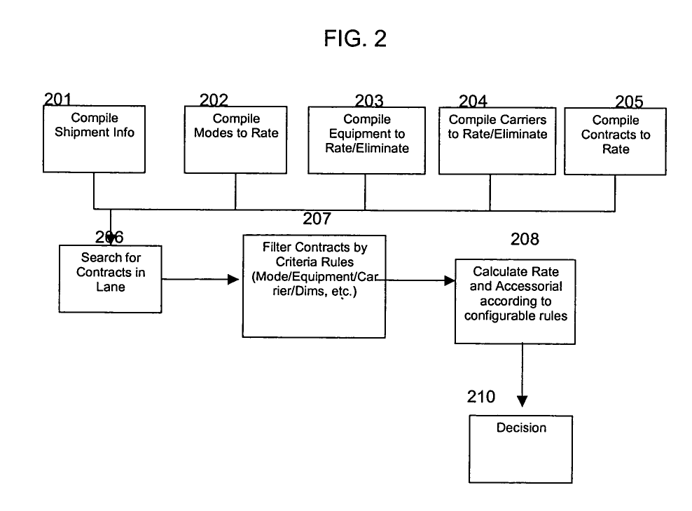

The shipping management tool 10, as embodied by the invention, provides a process and means to effectively manage material shipments, effectively manage global material shipments, and effectively manage material shipments of complex material shipments. An exemplary process for the shipping management tool 10 will be described herein with reference to FIG. 2. In FIG. 2, step 201, shipment and material information is compiled. The compiling, as embodied by the invention, may be loaded into the control or computer system 100, in any appropriate format, such as in word format, an excel spreadsheet, or other acceptable format.

The shipping management tool 10 also provides for other information to be complied into the control or computer system 100. For example, in step 202, material modes can be compiled into the control or computer system 100. In step 203, compiling of equipment or material to rate or eliminate as appropriate for the desired material shipment can occur. Step 204 permits compiling of one or more appropriate carriers so those one or more carriers can be rated as a potential carrier for the material shipment, or eliminated as a potential carrier for the material shipment. Further, at step 205 various existing or proposed contracts, contractual terms and/or desired contractual obligations (“contracts”) are complied and provided to the control or computer system 100.

In the compiling process, the rates may be calculated and compiled at step 202 using conventional means. These rate compiling means include, but are not limited to, algorithms, transfers functions, business decision software/programs, combinations thereof, and the like. For example, transit rates and times may be calculated. These calculations may consider information concerning road conditions, rail conditions, water conditions, existing and possible delays, construction along possible routes, weather information that may affect the shipment, and other transportation affecting factors that will affect the rates and transit times.

Contracts complied at step 205 will be dependent on several factors including, but not limited to, shipping management tool 10 user selected information. For instance, if the input for the transportation mode is by rail, the shipping management tool 10, as embodied by the invention, will look only for rail contracts and any other required parameters/elements compiled into the shipping management tool 10. Also, the shipping management tool 10 can investigate locations, for example by zip code, and looks for the contracts that have these zip code ranges; and any appropriate carrier.

The complied information from steps 201 through 205 is provided to the shipping management tool 10 at step 206, where the shipping management tool 10, as embodied by the invention, initiates one or more searches for one or more carriers that best align with the compiled information. The search at step 207 proceeds to filter contractual information at step 207 and can calculate rates and any other applicable criteria, at step 208. A decision can be made at step 210 as to the existence of an appropriate carrier(s) for the material shipments via the shipping management tool 10, as embodied by the invention.

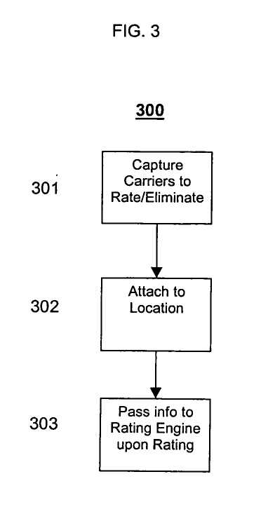

The shipping management tool 10, as embodied by the invention, further includes a banning (or elimination) process/module 300 for carriers. The banning process/module 300 will be described with respect to FIG. 3. The banning process/module 300 of the shipping management tool 10 can be employed if the user of the shipping management tool 10 is doing bulk material shipments planning. For example, if the shipping management tool 10, as embodied by the invention, determines that there is one or more carriers available, after the process of FIG. 1, the user can selects a “bulk planning” operation for the shipping management tool 10. The banning process/module 300 reviews the equipment type information and provides choices from the appropriate carrier via the shipping management tool 10.

The banning process/module 300, as embodied by the invention, is illustrated in FIG. 3. As illustrated in FIG. 3, the banning process/module 300 comprises step 301 in which carriers that are available, acceptable and/or appropriate are rated. Those carriers that are not available, acceptable and/or appropriate can be eliminated in step 301. In step 302, a review of available carrier locations is conducted and those available, acceptable and/or appropriate carriers are associated with those carrier locations. Lastly in step 303, the information with respect to available, acceptable and/or appropriate carriers are associated with carrier locations, is provided to the shipping management tool 10. This information is used in the decision making of which carrier to select. In other words, results for a particular material shipment and the shipping management tool 10, as embodied by the invention, will not permit assignment to a banned carrier. Carriers can be banned for various and sundry reasons, such as, but not limited to, legal reasons, material shipment limitations, business-decision related reasons, compliance reasons, and the like. These reasons are merely exemplary and are not intended to limit the invention in any manner.

An example of a material shipment limitation would be when user of the shipping management tool 10 desires “flat bed truck” in a 48 hour turn-around time period to be available for selection in the shipping management tool 10, as embodied by the invention. A “banned” carrier based on this material shipment criteria means that only carriers with flat bed trucks and that can provide 4-hour turnaround will be considered. All others will be “banned”. Thus, those who can provide 48 service but with a box truck are banned/eliminated and those flat bed truck carriers that can only commit to 72 hour turn-around service would also be eliminated.

Similarly, the shipping management tool 10, as embodied by the invention, the banning process/module 300 can also comprise a tool to evaluate if there are location constraints, time restrictions, or other such limitations that would or could prevent a carrier from meeting a desired material shipment. For example, material is desired to be shipped from Worcester, Mass. to Greenville, S.C. and the material is to be picked up on Saturday and delivered for 8 AM Monday. If the Worcester, Mass. location has shipping dock hours on Saturday only between 8 AM and noon, a carrier based in Chicago, Ill. that tries to accept the bid on Friday at 5 PM would most likely not be able to be in Worcester to pick up the material in order to deliver it. Thus, that carrier would be “banned”. Similarly, if the carrier is a one person/solo operation, and the material shipment is needed on an expedited basis that would require travel time greater than that allowed by a solo driver (based on driving time standards), that travel time criteria would “ban” that carrier. While these carriers would be banned, the shipping management tool 10, as embodied by the invention, would allow “appeal” of the ban, if desired by the user.

Similarly, the shipping management tool 10, as embodied by the invention, the banning process/module 300 can also comprise a tool to evaluate if there are weight and/or size constraints, which would or could prevent a carrier from meeting a desired material shipment. For example, but in no way limiting of the invention, the shipping management tool 10 can evaluate a carrier on the basis of the ability to adequately carry and ship the material. For example, and in no way limiting of the invention, the shipping management tool 10 can evaluate if a carrier has an acceptable piece of equipment to carry, and carry safely, the material to be shipped. If the material is a 15-ton generator, the shipping management tool 10 can determine and evaluate if the carrier has equipment adequate to safely and properly haul the generator. Additionally, if the material to be shipped is a wind turbine tower, for example a 90 foot section of the wind tower, the shipping management tool 10, as embodied by the invention, will determine if carrier A can safely carry such a long, heavy, and unstable item.

Of course, the above are merely examples of the various investigations that the shipping management tool 10 can use to determine if a carrier is appropriate for the desired material shipment. For example, a particular material shipment receiver, such as, but not limited to, a customer, does not want to use a particular carrier or if a carrier provide discounts for particular routes or the like, these criteria can also be loaded into the shipping management tool 10.

Additionally, if there are two or more “appropriate” carriers, the shipping management tool 10, as embodied by the invention, can be used to determine the most economic and desirable if a carrier is appropriate for the desired material shipment. This use of the shipping management tool 10 can reduce cost for both the shipping party, which can be passed onto the receiver in many different forms.

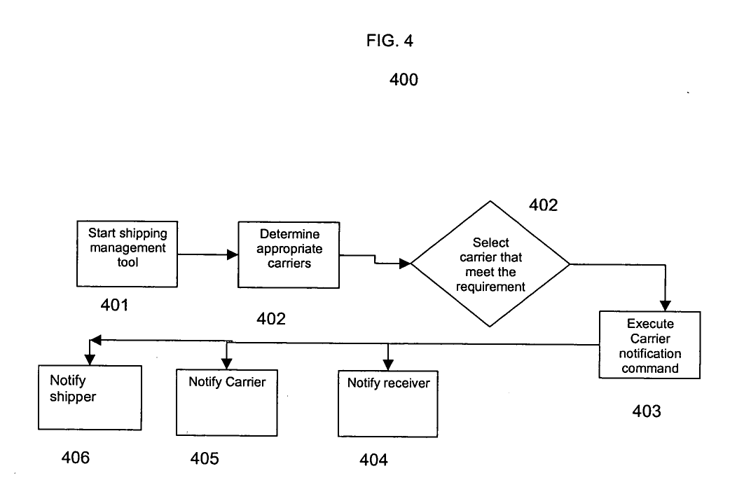

Another aspect of the shipping management tool 10 includes a notification capability. The shipping management tool 10, as embodied by the invention, can send notifications to the shipping party, the receiver, and the carrier with pertinent information concerning shipping. The process comprised in the notification capability 400 is schematically illustrated in FIG. 4. In step 401, the shipping management tool 10 is started and evaluates the various shipping criteria, as noted and described above. In step 402, appropriate carriers are determined, and step 403, the carrier is selected based on the various shipping criteria that have been loaded into the shipping management tool 10, as embodied by the invention. Next, with the carrier selected, the receiver, the shipper, and the carrier can be automatically notified as a result of the shipping management tool 10 decision making tools and processes. The notification can take any suitable means, such as but not limited to, regular mail, e-mail, telephone call, pagers, facsimile, Internet messages, and similar communications.

The notification capability of the shipping management tool 10 can include any desired and useful information that any one of the shipper, receiver, and/or carrier would like to receive. For example, and in no way limiting of the invention, the notification may provide a current status of the shipment, change in status, and any action required by the parties. The notification may also include a description of the material shipment.

The previously described embodiments of the present invention have many advantages, including allowing interaction by various parties into the shipping management process, allowing the shipping party to control carriers by evaluation its critical to quality criteria, weigh various factors that influence carrier and shipping management decisions with the ultimate control being with the shipping party, and automation of a manually intensive process.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A shipping management tool, the tool comprising:
a system that allows for information to be loaded therein;
means for compiling at least one of shipment and material information into the system;
means for rating information representative of the material to be shipped;
means for compiling information concerning one or more carriers for the material to be shipped;
means for evaluating the carriers based on one or more of existing and proposed contracts, contractual terms and desired contractual obligations; and
means for determining an appropriate carrier based on the means for compiling at least one of shipment and material information, and means for rating, and means for compiling information concerning one or more carriers, and means for evaluating the carriers.

2. A tool according to claim 1, wherein the means for determining an appropriate carrier comprises means for searching for carriers that align with the compiled information.

3. A tool according to claim 1, wherein the means for determining an appropriate carrier comprises means for eliminating carriers based on carrier weight capability.

4. A tool according to claim 1, wherein the means for determining an appropriate carrier comprises means for eliminating carriers based on carrier location.

5. A tool according to claim 1, wherein the means for determining an appropriate carrier comprises means for eliminating carriers based on carrier equipment.

6. A tool according to claim 1, wherein the means for determining an appropriate carrier comprises means for eliminating carriers based on carrier scheduling capability.

7. A tool according to claim 1, wherein the system comprises a computer that accomplishes the means for determining an appropriate carrier based on the steps of means for compiling at least one of shipment and material information, and means for rating, and means for compiling information concerning one or more carriers, and means for evaluating the carriers.

8. A tool according to claim 1, wherein the tool further comprises notification capability to inform at least one of a shipper, receiver, and carrier of a material shipment.

9. A tool according to claim 8, where the notification capability comprises at least one of: regular mail, e-mail, telephone call, pagers, facsimile, Internet messages.

10. A shipping management process, the process comprising:
compiling at least one of shipment and material information into a system;
rating information representative of the material to be shipped;
compiling information concerning one or more carriers for the material to be shipped;
evaluating the carriers based on one or more of existing and proposed contracts, contractual terms and desired contractual obligations; and
determining an appropriate carrier based on the steps of compiling at least one of shipment and material information, and rating, and compiling information concerning one or more carriers, and evaluating the carriers.
